(19) United States
(12) Patent Application Publication
(10) Pub. No.: US 2003/0156805 A1
(43) Pub. Date: Aug. 21, 2003

(54) Indoor wiring optical cable

(76) Inventor: Xinhai Shi, Shanghai (CN)

Correspondence Address: RABIN & BERDO, P.C., Suite 500, 1101 14 Street, N.W., Washington, DC, 20005, US

(21) Appl. No.: 10/319,490

(22) Filed: Dec. 16, 2002

(30) Foreign Application Priority Data
Dec. 25, 2001 (CN) CN 01279142.3

(51) Int. Cl. G02B 6/44

(52) U.S. Cl. 385/100

(57) ABSTRACT

The invention relates to an indoor wring optical cable. It consists of optical fiber, core bundling pipe, PE inner protecting layer, moistureproof layer, shielding and isolating layer of aluminum-plastics film, metallic knitted net and outer protecting jacket. Its structure is that the optical fiber is packed with core bundling pipe, PE inner protecting layer, moistureproof layer, shielding and isolating layer of aluminum-plastics film, metallic knitted net and outer protecting jacket in turn. It has the advantages of softness, lightness, good mechanic performance, anti-bent, anti-flexibility, anti-strain, anti-impact, anti-extrusion, anti-corrosion and easy to operation, move and construction. It can resist the radiation of outer high electromagnetism field on interfering signal transmitted in the optical fiber and resist the OH-group of water in moisture air resulting in direct corrosion damage on optical fiber. It also has the performance of flame-retardant.

### FIELD OF THE INVENTION

The present invention relates to an indoor wiring optical cable. Specifically, it is concerned with an optical cable wiring and distribution, which are appropriate to be used in exchange and transmission office in telecom project, and an indoor (or used by the telecom exchange and transmission office) wiring optical cable, which is appropriate to be used in the integrated optical cable distribution in buildings.

### BACKGROUND ART

At present, with the rapid development of national economy, the construction of the digital information project is developing with each passing day in our country. At the same time, it drives the development of the construction of the optical cable communication project. Therefore, the integrated distribution of indoor optical cable for entering buildings and entering house become more important. However, by now there are no appropriate indoor optical cable that can be used in the present optical cable communication project, so the optical cable distribution used by exchange and transmission office in telecom project and the integrated optical cable distribution in buildings are all generally adopting field optical cable. Because of the structure feature, the field optical cable has high rigidity and lacks the soft performance so that can't be bent easy, and too heave to move, that results in many inconveniences and affects the quality of the project. Therefore, the development study of the optical cable wiring and distribution used in exchange and transmission office in telecom project, and an indoor (or used by the telecom exchange and transmission office) wiring optical cable that used in the integrated optical cable distribution in buildings is very important.

### DISCLOSURE OF THE INVENTION

The object of the present invention is to design an optical cable wiring and distribution, which are appropriate to be used in exchange and transmission office in telecom project, and an indoor (or used by the telecom exchange and transmission office) wiring optical cable, which is appropriate to be used in the integrated optical cable distribution in buildings. The invention makes up for the present technology insufficiency.

The object of the present invention is achieved as follow: The indoor wiring optical cable consists of optical fiber, core bundling pipe, PE inner protecting layer, moistureproof layer, shielding and isolating layer of aluminum-plastics film, metallic knitted net and outer protecting jacket. Its structure is that the optical fiber is packed with core bundling pipe, PE inner projecting layer, moistureproof layer, shielding and isolating layer of aluminum-plastics film, metallic knitted net and outer protecting jacket in turn.

Compared with the present technology, the present invention has the advantages of softness, lightness, good mechanic performance, anti-bent, anti-flexibility, anti-strain, anti-impact, anti-extrusion, anti-corrosion and easy to operation, move and construction. The indoor wiring optical cable can resist the radiation of outer high electromagnetism field on interfering signal transmitted in the optical fiber and resist the OH-group of water in moisture air resulting in direct corrosion damage on optical fiber. It also can retard flame and has a high reliability.

The present invention is further illustrated with the following drawings and examples.

### BRIEF DESCRIPTION OF THE DRAWINGS

FIG. 1 is a structure view of the invention.

FIG. 2 is a cross section view of the invention.

Wherein: optical fiber—1, core bundling pipe—2, PE inner protecting layer—3, moistureproof layer—4, shielding and isolating layer of aluminum-plastics film—5, metallic knitted net—6, outer protecting jacket—7.

### EXAMPLES

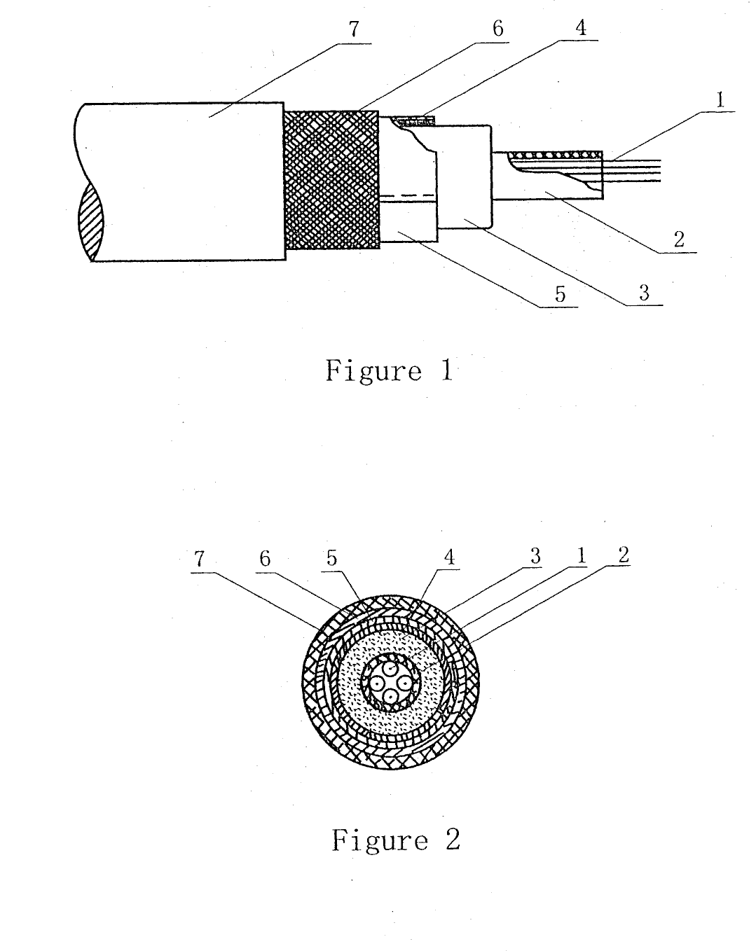

The FIGS. 1 and 2 show that the indoor wiring optical cable consists of optical fiber 1, core bundling pipe 2, PE inner protecting layer 3, moistureproof layer 4, shielding and isolating layer of aluminum-plastics film 5, metallic knitted net 6 and outer protecting jacket 7. The said optical fiber 1 is made of core of quartz glass fiber and plastics packing layer. The thickness of the packing layer must be uniformity. The outer diameter of the said optical fiber is 100-150 μm. The said core bundling pipe 2 is a cannula that packs the core and houses 1-12 color optical fibers with chromatographic series. The material used in making said core bundling pipe (2) is PBT, PE or PP and dimension of outer diameter of core bundling pipe (2) is 1.5-3.0 mm. The use of said PE inner protecting layer 3 is that the optical fiber 1 can keep effective protect and avoid destroy from outside force and environment. The PE material of PE inner protecting layer (3) used in packing core bundling pipe (2) is treated by physical or chemical foam process. The dimension of outer diameter of the inner protecting layer (3) is 4.0-7.0 mm. The material used in making said outer protecting jacket (7) is PVC with good performance of flame retardant and the thickness of said outer protecting jacket (7) is 1.0-1.5 mm.

The structure of the indoor wiring optical cable is that the optical fiber 1 is packed with core bundling pipe 2, PE inner protecting layer 3, moistureproof layer 4, shielding and isolating layer of aluminum-plastics film 5, metallic knitted net 6 and outer protecting jacket 7 in turn.

What is claimed is:

1. An indoor wiring optical cable consisting optical fiber (1), core bundling pipe (2), PE inner protecting layer (3), moistureproof layer (4) shielding and isolating layer of aluminum-plastics film (5), metallic knitted net (6) and outer protecting jacket (7) has the structure that the optical fiber (1) is packed with core bundling pipe (2), PE inner protecting layer (3), mositureproof layer (4), shielding and isolating layer of aluminum-plastics film (5), metallic knitted net (6) and outer protecting jacket (7) in turn.

2. An indoor wiring optical cable as claimed in claim 1, wherein said core bundling pipe (2) houses 1-12 color optical fibers (1) with chromatographic series.

3. An indoor wiring optical cable as claimed in claim 1, wherein the material used in making said core bundling pipe (2) is PBT, PE or PP and the dimension of outer diameter of said core bundling pipe (2) is 1.5-3.0 mm.

4. An indoor wiring optical cable as claimed in claim 1, wherein the PE material of said PE inner protecting layer (3) used in packing core bundling pipe (2) is treated by physical or chemical foam process and the outer diameter of PE inner protecting layer (3) is 4.0-7.0 mm.

5. An indoor wiring optical cable as claimed in claim 1, wherein the material used in making said outer protecting jacket (7) is PVC with good performance of flame-retardant and the thickness of said outer protecting jacket (7) is 1.0-1.5 mm.
